(19) United States
(12) Patent Application Publication
(10) Pub. No.: US 2012/0262125 A1
(43) Pub. Date: Oct. 18, 2012

(54) METHOD AND CHARGE CONTROL FOR PROLONGING THE USEFUL LIFE OF BATTERIES

(76) Inventors: Jochen Fassnacht, Calw (DE); Roland Norden, Markgroeningen (DE)

(21) Appl. No.: 13/500,124

(22) PCT Filed: Aug. 26, 2010
(86) PCT No.: PCT/EP2010/062428

§ 371 Date: Jun. 22, 2012

(30) Foreign Application Priority Data
Oct. 19, 2009 (DE) 10 2009 045 784.4

(51) Int. Cl. H02J 7/00

(52) U.S. Cl. 320/162

(57) ABSTRACT

A method for prolonging the service life of a traction battery of an electric-powered or hybrid vehicle. The method includes recording at least one driving phase selection that encompasses a travel duration, a start of driving, or both; and recording an instantaneous state of charge of the traction battery. At least one aging parameter is minimized that encompasses the time interval between a charging process and the start of driving or the charging energy used to charge the traction battery in accordance with at least one driving phase selection; and the charging process is executed in accordance with the minimized aging parameter. Also, a charge control for implementing the method.

### FIELD OF THE INVENTION

The present invention relates to an improved charge strategy for preventing aging processes in batteries used for propelling electric-powered and hybrid vehicles.

### BACKGROUND INFORMATION

Conventionally, electric-powered vehicles, i.e., electric automobiles or hybrid vehicles, are provided with traction batteries that are charged by a power supply system. Under conventional methods, the charging process has been controlled with the aim of optimizing the travel range, as well as the vehicle availability. This is achieved by charging processes which begin as early as possible, in particular, directly upon connection of the electric-powered vehicle to a power supply system, and which result in the battery being fully charged.

Besides charging a permanently installed battery, conventional approaches provide for replacing a battery; such approaches entailing a significantly higher material expenditure and a problematic design of the electrical contacts, however.

Conventional charge strategies do not allow for aging processes that arise from immediate, complete charging, however. The aging processes restrict the travel range of the vehicles, as well as the availability thereof.

It is an object of the present invention to provide a charge strategy and a charge control that will make it possible to increase the travel range and the availability of the vehicles.

### SUMMARY

In accordance with the present invention, it has been recognized that a significant proportion of aging processes that result in reduced availability and battery capacity are caused by certain aging parameters that are able to be substantially reduced by an appropriate charge strategy. It has been recognized that aging of the batteries is caused by: the state-of-charge cycle range, i.e., the charging energy used to bring the battery to a higher state of charge; as well as the time period during which the battery has a high state of charge since, for example, the electrolyte of the battery decomposes at a much higher rate at a high state of charge, for example in the case of a fully charged battery, than at a lower state of charge. In accordance with the present invention, the charge strategy targets these causes of aging, i.e., the charge strategy parameters (i.e., the length of time, begin, transferred charging energy and other parameters) are provided with the aim of minimizing the aging parameters, such as immobilization time under conditions of a high state of charge or high state-of-charge cycle range.

Therefore, an example embodiment of the present invention provides for recording at least one driving phase selection, for example the travel duration (or equivalently the travel range) or the start of driving. Since the travel duration (respectively, the travel range) is linked to a minimum state of charge, which, in turn, defines the charging energy to be minimally transferred, an upper limit may be derived from the travel duration and be used to adjust the charging energy. In other words, the charging energy is minimized with the aim of transferring only a minimal amount of charging energy to the battery, an amount that only just suffices for the traction battery to supply, respectively to ensure that it supply sufficient power to the drive of the electric-powered or hybrid vehicle. Therefore, only the minimum required amount of energy is transferred to the traction battery during the inventive charging process in order to thereby minimize the state-of-charge cycle range. Instead of the travel duration, a travel range of the vehicle may also be specified, both the travel duration, as well as the travel range of the vehicle being linked to a state of charge that makes them possible.

The interrelationship between the travel duration (or travel range) and the state of charge may be provided by an estimation or through empirical data; in some instances, variances making it necessary to add an additional safety margin in the form of an additional charging energy value to the requisite charging energy in order to ensure a sufficient travel range, respectively to meet the recorded driving phase selection, even in the case of overly positive estimations. Therefore, the present invention provides that the battery be charged only to the level required by the driving phase selection and, in particular, by the travel duration, respectively the travel range, making it possible to minimize aging processes caused by the state-of-charge cycle range (i.e., the change from a low to a high state of charge). Therefore, it is readily apparent that, in accordance with the driving phase selection, the next drive requires a travel range only over a modest short distance. Thus, at a low state of charge, the traction battery is not fully charged, rather is charged only to the level where the state of charge meets the travel range requirements following the charging operation.

An example embodiment of present invention also provides that the start of driving be recorded, allowing the charging process to be adjusted to the start of driving in order to thereby minimize the time interval as an aging parameter. It is, therefore, a realization of the present invention that the battery ages considerably under conditions of a fully charged state or a high state of charge, in particular, so that, to reduce aging, the battery should have a high state of charge for only the shortest time possible. Therefore, at least one stage of the charging process is delayed in accordance with the driving phase selection (in particular, in accordance with the start of driving) until the end of the charging process coincides substantially with the start of driving. This makes it possible to avoid immobilization times during which the battery has a high state of charge and thus ages considerably. The present invention also takes the travel duration into consideration in the delaying of the charging process; the charging energy still needed to ensure the predefined travel duration being derived from the travel duration. The charging duration, in turn, together with the charging current, respectively the charging power, yields the charging duration still required, allowing the start of charging to be calculated on the basis of the specified start of driving in consideration of the charging duration. Thus, in accordance with the present invention, the charging process is oriented in duration and start thereof to the start of driving, as well as to the charging duration, which, in turn, is a function of the travel duration (and of the state of charge). Therefore, the start of the charging process is derived from the specified start of driving, which is advanced in time by the charging duration (and, in some instances, by an additional safety margin), to ensure that the battery have a state of charge that is appropriate for the specified travel duration (or the specified travel range) at the specified start of driving.

The charging process may also be in two stages; a first stage of the charging process not being oriented to the aging parameters, as is provided by the present invention; however, a second or further subsequent stage providing for delayed charging, respectively for reducing charging energy to minimize a charging state in terms of the travel duration, respectively the travel range, in order to minimize the aging parameter in accordance with the present invention. In this case, however, the first stage is carried out using a state-of-charge range, respectively a charging energy that does not result in a high state of charge. Rather, the first stage is directed to ensuring a minimum state of charge, so that it is oriented to a specified state of charge (for instance, 20 or 50%), for example, that basically allows the vehicle to be available even before the specified start of driving, even if not for a particularly long travel range. However, the second, respectively further stage of the charging is oriented to the driving phase selection and minimizes the aging parameters associated therewith by delaying the start of charging assigned to the second stage, as well as by minimizing the charging energy in accordance with a specified travel duration, respectively specified travel range.

Thus, the example method according to the present invention provides for prolonging the service life of a traction battery by first recording a driving phase selection that encompasses a travel duration (respectively a travel range), a start of driving, or both. This driving phase selection may be derived from earlier implemented driving phases, and may be provided by a user input, or both. In addition, the instantaneous state of charge of the traction battery may be recorded, for example via the terminal voltage or an internal resistance that is ascertainable on the basis of the terminal voltage and the flowing current, or on the basis of a combination of these variables along with the temperature. Numerous methods for recording the state of charge are possible, inter alia model-based states of charge; a model simulating certain chemical processes within the battery, and this model being updated on the basis of measured variables to be externally detected; the measured variables including terminal voltage, current and temperature, for example. The state of charge may be estimated or extrapolated on the basis of the model and/or on the basis of the measured variables. The recorded instantaneous state of charge is used for estimating the charging, respectively the charging energy still required to achieve the specified travel duration.

The service life is prolonged in accordance with the present invention by minimizing an aging parameter, the aging parameter describing the time interval until a charging process or including the charging energy. The time interval until a charging process corresponds to the length of time in which the traction battery has a low state of charge; low states of charge diminishing aging and high states of charge intensifying aging. Minimizing an aging parameter that describes the time interval until the charging process corresponds to maximizing this length of time. Thus, the aging parameter reflects the length of time in a complementary form.

Instead of or in combination with the time interval until a charging process, a complementary variable may be used, i.e., the time interval until the start of driving, under the condition that the time interval until the start of driving begins at the time the transfer of the charging energy ends.

In this case, the time interval until the start of driving is an aging parameter to be minimized that increases along with aging since the length of time during which the battery has a high state of charge increases along with the aging. On the other hand, if the time interval until a charging process is used and is expressed as an aging parameter, then aging decreases in response to a lengthening time interval until the charging process since the traction battery is subjected all the less to a long period of time at a high state of charge, the longer the time interval is until a charging process. Therefore, the time interval until a charging process relates to the time period in which the traction battery has a low state of charge and thus ages at a significantly lower rate than when it has a high a state of charge.

In addition, an example embodiment of the present invention provides that the charging energy used to charge the traction battery be minimized in accordance with the at least one driving phase selection. The charging energy corresponds to the state-of-charge cycle range and may be minimized in accordance with the charging duration, so that the charging energy does, in fact, ensure the specified travel duration, but only just (as minimally as possible) exceeds that value which would exactly ensure the travel duration.

The minimization is provided in accordance with the driving phase selection. Thus, the time interval until a charging process is maximized, whereby the corresponding aging component (thus, the aging component that is in a complementary relationship therewith) is minimized by taking the start of driving into consideration, and by delaying the charging long enough to ensure that the desired charging energy is transferred as closely as possible in time to the start of driving. It is provided that the time interval until the start of driving, i.e., the time period between the end of the charging process (i.e., the transfer of the charging energy) and the start of driving be minimized by delaying the charging process and, thus, also the end of the charging process to the extent possible, so that, given an optimal minimization, the thus postponed charging process ends exactly at the time the start of driving is intended. A minimization in accordance with the charging energy is provided in that the travel duration, respectively the corresponding travel range is used to provide the requisite state of charge on the basis of the recorded, instantaneous state of charge. In this case, the charging energy is kept as low as possible, so that, on the basis of an instantaneous state of charge prior to the charging, a state of charge is provided following the transfer of the charging energy that, in fact, does ensure the travel duration and the travel range, but does not provide for any significant amounts of energy exceeding the same to be stored in the traction battery. Thus, the state of charge is minimized prior to the start of driving. The example embodiment of the present invention provides that the method also include the step of implementing the charge process in accordance with the minimized aging parameter. In this case, the charging process is carried out in accordance with the maximized time interval until a charging process; in accordance with the minimized time interval between the end of the charging process and the start of driving, and/or the minimal charging energy required to ensure the travel duration, respectively the travel range.

Therefore, the travel duration is recorded by inputting the travel duration itself or, in particular, the planned travel range. The charging energy still necessary is computed on the basis of the input travel range and a predefined consumption value, taking into account an instantaneous state of charge.

In particular, in planning the charging process to be carried out, the charging energy, which is still to be supplied and is linked to the intended travel range, is taken into consideration, by taking into account the charging duration, which is linked to the charging energy, when scheduling the start of the charging process. Instead of inputting an intended travel range, for example via a user interface, a travel range of past drives, preferably a plurality of travel ranges may also be retrieved on whose basis, a travel range is provided by averaging or extrapolation, for example. Thus, travel ranges of past drives are linked in a learning process in order to provide a travel range to minimize the aging parameters. The charging energy is minimized on the basis of the travel range, the instantaneous state of charge (prior to the charging process) being recorded, in particular, in order to provide the remaining charging energy needed until a nominal state-of-charge is reached that corresponds to the travel range. The charging energy is estimated as a function of the travel range and is provided by a logic operation. The logic operation is provided, for example, by an approximation formula, a ratio of state-of-charge reduction to the distance traveled in a past drive (i.e., the consumption value of a past drive), an interpolation, or by a look-up table. The traction battery is then charged using the minimized charging energy. Alternatively, the traction battery is charged using the minimized charging energy that is increased by an availability safety margin. Thus, the availability safety margin also covers variances or travel ranges that go (slightly) beyond the planned travel range.

In addition, the start of driving is recorded as a driving phase selection. The start of driving is recorded by inputting a planned start of driving, for example via a user interface or by retrieving at least one start of driving of past drives, for example of a start of driving averaged or extrapolated from the starts of driving of past drives. In this case, the minimization is provided in that the time interval until the beginning of the charging process is minimized on the basis of the start of driving and an estimated charging duration. The charging duration is dependent on a charge deficit, respectively on the charging energy that is necessary for a specified travel range or travel duration. In addition, the time interval until the begin of the charging process is estimated on the basis of an available charging power that indicates the ratio of the amount of charging energy to the charging time required therefor. For example, if the energy deficit or the charging energy is indicated in Ah, then the charging power reflects the energy flow in the form of a current intensity (i.e., in the form of A) when a constant terminal voltage is assumed. The charging duration is then expressed by the quotient of charging energy or charge deficit and charging power. The charge deficit is comparable to the charging energy needed to provide a desired, retrievable amount of energy at the end of the charging process. The charge deficit corresponds to the difference between a specified minimum state of charge and the instantaneous state of charge. The specified minimum state of charge state is determined, in particular, by a travel range, respectively by a travel duration for which the traction battery must at least hold available charging power, respectively energy in readiness.

The minimum state of charge is provided as a function of the travel range, for example by estimation. The minimum state of charge is provided in that, starting out from the travel range, a logic operation is performed between the minimum state of charge and the travel range. It expresses a value for the consumption by the vehicle (energy required in relation to the distance traveled using this energy). The logic operation between the minimum state of charge and the travel range is provided, for example, by an approximation formula, a ratio of state-of-charge reduction to the distance traveled in a past drive, an interpolation, or by a look-up table, or by any given combination thereof. The ratio of the state-of-charge reduction to distance traveled corresponds to the consumption that occurred during past drives, it being possible for this to be averaged for past drives or extrapolated on the basis thereof; in some instances, in consideration of a consumption class that is assigned to the distance of a past drive (for example, a drive at a high velocity, such as a drive on the turnpike, corresponds to a high consumption class, while a drive at a moderate speed and constant rate is assigned to a low consumption class).

In accordance with another specific embodiment of the present invention, the example method encompasses the recording of the traction battery temperature. If the temperature is too low, the charging process is not fully implemented or is not implemented in accordance with the present invention to prevent any damage to the battery due to too low operating temperatures. For that reason, the temperature is compared to a minimum specified temperature, and the charging process is carried out in accordance with the minimized aging parameters only if the comparison step reveals that the recorded temperature corresponds to the minimum specified temperature or is above the same. Similarly, the minimization step and the step of recording the instantaneous state of charge, or also the step of recording at least one driving phase selection may be carried out only if the recorded temperature is above the minimum specified temperature or corresponds thereto; one or more of these steps not being performed if the comparison step reveals that the recorded temperature is below the minimum specified temperature. Suspending the example method according to the present invention in response to too low temperatures (below the minimum specified temperature) avoids any damage to or premature aging of the battery caused by a charging process at too low temperatures.

The example method according to the present invention provides for a charging process in one or multiple stages; in a multistage charging process, at least one stage, in particular the last stage of the charging process, being executed in accordance with the present invention. Therefore, a first stage of the charging process is not executed in accordance with the minimized aging parameter. By increasing the state of charge, the at least one first stage, which is not executed in accordance with the minimized aging parameter, makes it possible to augment the availability for drives that are not carried out in accordance with the intended travel duration or the scheduled start of driving. At least one other, second stage of the charging process is executed in accordance with the minimized aging parameter. Therefore, the at least one further, second stage of the charging process is executed during a minimized time period between the end of the charging process and the start of driving, respectively is implemented using minimized charging energy. The one second stage or the plurality of second stages is/are executed following the one first, respectively the plurality of first stages, either following completion of the first stage or immediately thereafter, or also with a time delay that conforms to the minimized time interval between the end of the most recent charging process and the start of travel. While, at the same time, the one second or the plurality of second stages minimizes/minimize the aging of the battery, the first stages, respectively the first stage allow/allows a certain basic charge to be supplied to the battery, respectively to reside therein, to permit drives that do not conform with the intended travel duration or the scheduled start of driving, thereby increasing availability, but without intensifying aging to the same degree.

In accordance with one multistage charging process, the first stage of the charging process provides for charging the traction battery to a specified minimum charge value or to a charge state that corresponds to a specified minimum travel range, thereby increasing the minimum availability beyond the scheduled drive as well. The first stage is preferably implemented immediately following the connection of the electric-powered or hybrid vehicle, or of a charging device of the traction battery to a power supply system, however, not in accordance with the minimized aging parameter (i.e., minimized by a maximally delayed start of the charging process). The (at least one) second stage of the charging process encompasses minimizing and executing at least this stage in accordance with the minimized aging parameter. The second stage of the charging process is delayed in accordance with the start of driving (the charging duration) and the travel duration. In addition, the at least one second stage may be implemented in accordance with a charging energy that is minimized in accordance with the travel duration, respectively the travel range. In particular, the second stage may be delayed both in accordance with the start of driving and travel duration to minimize the aging parameters, and also be implemented in conformance with a minimized charging energy that is minimized in terms of the travel duration, respectively the travel range.

Furthermore, the present invention is realized by a charge control for a traction battery of an electric-powered or hybrid vehicle that encompasses an input interface, a state-of-charge detection device and a minimization device. The input interface is adapted for inputting a driving-phase selection that encompasses a travel duration or a start of travel, or both. The state-of-charge detection device is adapted for recording an instantaneous state of charge of the traction battery. To this end, the charge control may encompass an interface that is adapted for receiving measured variables, such as terminal voltage, current and/or battery temperature, from the traction battery. The state-of-charge detection device may feature a logic operation between these measured variables and the states of charge, for example in the form of an approximation, a look-up table, an interpolation device or a model, preferably a combination thereof. The minimization device is adapted for minimizing the aging parameter in accordance with the driving phase selection and the state of charge. The aging parameter reflects the time interval until a charging process or, in a complementary form, corresponds to a time interval between the charging process (the end of the charging process) and the start of driving.

Generally, the aging, which is described by the aging parameter, increases with decreasing time interval until the charging process, respectively with increasing time interval between the charging process and the start of driving. In the same way, the aging, which is expressed by the aging parameter, increases with the charging energy since the state-of-charge cycle range associated therewith increases in response thereto. As already noted, the charging energy is provided in accordance with the minimum amount of energy required for the specified travel duration, a minimization of the aging parameter corresponding to a maximization of the time interval until a charging process, respectively to a minimization of the interval between the charging process and the start of driving, whereby the length of time during which the battery has a high state of charge is minimized along with the aging. Accordingly, the minimization device is adapted for optimizing the time interval until a charging process in accordance with the travel duration and/or in accordance with the start of driving. In addition, the minimization device is adapted for optimizing the charging energy in accordance with the travel duration, i.e., for minimizing the same. An optimization of the time interval until a charging process corresponds to a maximization of the time interval between the charging process and the start of driving, respectively to a minimization of the time interval between (the end of the) charging process until the start of driving. The charging energy, as well as the time interval are preferably optimized. In addition, the charge control includes an output that is adapted for outputting a charging signal or a charging current in conformance with the optimized aging parameter. In this connection, the charging signal, respectively the supplying of the charging current conform to the minimal charging duration; a minimized charging energy, and a charging process that has been delayed to the extent possible having a maximum time interval until a charging process, respectively a minimal time interval between the charging process and the start of driving. The minimization device adapted for this optimization controls the output of the charge control, so that a charging device or a traction battery that is connectable thereto is charged in accordance with the optimized data.

A user interface may be provided for inputting the travel duration and the start of driving. In accordance with another specific embodiment, the charge control includes a memory that is adapted for storing values of past recorded travel durations or start-of-driving points in time. Such travel durations or start-of-driving points in time may be specified by the vehicle electronics which inputs the start, duration, and/or end of the driving operation into the memories of the charge control via an input interface thereof. In addition, the charge control is adapted for interpolating or averaging these stored values in order to input them into the input interface of the charge control, in particular of the minimization device, in order to provide them with the driving phase selection. In this variant, the driving phase selection is not conveyed to the charge control by a direct user input, rather it is ascertained by recorded past drives of the vehicle. In this connection, the past travel durations and/or start-of-driving points in time are considered in the minimization in accordance with the driving phase selection. In this case, the past travel durations and start-of-driving points in time supersede the driving phase selection. The memory makes it possible for the charge control to learn the user behavior from past drives and provide a driving phase selection from that which is learned.

Another variant of the present invention provides for a clock to be part of the charge control in order to transmit the current time to the minimization device, which may subsequently provide the time interval between the charging process and the start of driving in order to correspondingly implement the charging process in accordance with the minimized data.

### BRIEF DESCRIPTION OF THE DRAWING

FIG. 1 shows exemplarily conventional charging processes, as well as charging processes in accordance with the present invention.

### DETAILED DESCRIPTION OF EXAMPLE EMBODIMENTS

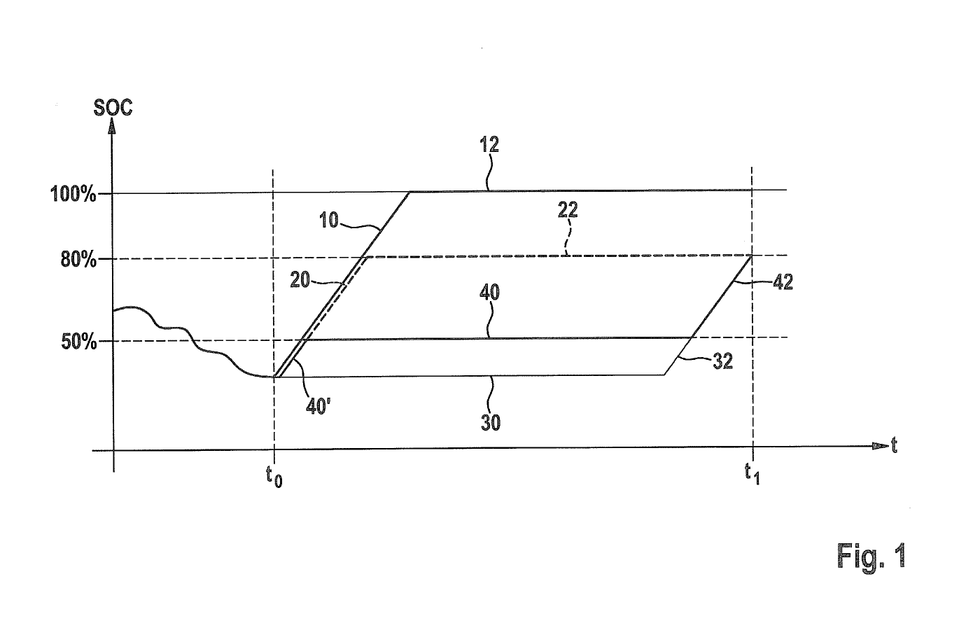

FIG. 1 shows the characteristic curve of the state of charge (SOC) as a function of time characteristic t. The state of charge is first reduced until point in time t₀ by a preceding drive. The drive ends at point in time t₀, and the vehicle is connected to a power supply system that supplies the charging energy. Immediately following connection to the power supply system, the charging process is started in accordance with a conventional charging process, resulting in a continuous rise in the state of charge. The increase in charge state 10 is continued until a maximum charge state, i.e., 100% is reached, whereupon the supplying of charging energy is ended, and the charge state assumes constant level 12, so that the state of a fully charged battery is maintained until point in time t₁ which denotes the start of driving. From FIG. 1, it is readily apparent that a significant aging process occurs because of the long period of time during which the battery has a high state of charge. On the one hand, the long duration of the state leads to aging as does, on the other hand, the high charge state during this duration.

For that reason, the charging energy is minimized in accordance with a first example implementation of the present invention, so that, a charging process is, in fact, begun at point in time T₀, in order to provide a rise 20 in the state of charge; however, the rise is not carried out to the maximum state. The charging, which is represented by rise 20, is ended upon reaching a predefined charging level that corresponds to a predefined charging energy. In the example of FIG. 1, this level corresponds to an 80% state of charge, so that, upon reaching this state of charge, the charging is ended, and a state-of-charge level 22 is maintained until point in time t₁ is reached. This charge curve, composed of curve sections 20 and 22, shows a minimization of the charging energy, so that the aging is reduced, since it is intended that the battery be at a lower state of charge 22 up to point in time t₁. Thus, the aging is reduced. The exemplary 80% state of charge here, which corresponds to level 22, corresponds to the travel duration, respectively the travel range that traction battery must produce at a minimum.

In particular, another alternative specific embodiment of the present invention provides that the time interval until a charging process be maximized, respectively the interval between the charging process and start of driving be minimized. The corresponding charge curve initially shows a constant level 30 that ensues immediately at point in time t₀ and corresponds to a state of charge that prevails upon completion of the most recent drive. State 30 is maintained as long as possible, so that the charging process, as represented by rise 32 in the state of charge, is implemented at the latest possible time. Thus, the charging process, represented by rise 32, is delayed to the extent possible, so that, during level 30, the traction battery features a low state of charge, which is associated with a low rate of aging. The start of charging, i.e., the base point of rise 32, corresponds to start of driving t₁, that had been advanced by a length of time that the charging process takes. The length of time that the charging process takes is derived from the difference between the state of charge at point in time t₀ and the state of charge that corresponds to the travel duration, respectively travel range (in this case, 80%), as well as from the charging power used to increase the state of charge in relation to the corresponding time duration. Since the rate of increase of rise 32 is known, the requisite start of the charging process may, therefore, be calculated starting from start of driving t₁.

Other methods (not described) provide for an additional length of time by which the charging process is additionally advanced in order to provide a sufficient charge for the battery when the start of driving is advanced in an unscheduled manner. In comparison to characteristic curve 20, 22, it is most notably the charging time period in accordance with characteristic curve 30, 32 that reduces the aging. Moreover, the minimizations in accordance with the present invention (i.e., the time interval and charging energy) are implemented in accordance with characteristic curve 30, 32, on the one hand, by postponing the start of the charging process to the extent possible and, on the other hand, by not implementing the charging up to the maximum possible charge state; rather, by reducing it in accordance with a minimized charging energy that ensures a travel duration, respectively a travel range, however, does not provide for storing any energy amounts that go substantially beyond that.

Characteristic curve 40, 42 represents another specific embodiment of the present invention where the charging process is carried out in two stages. A first charging begins in accordance with rise 40′ in the state of charge immediately at point in time tₒ. The purpose of this first stage of charging process 40′ is to provide a specified minimum charge state (here 50%), so that, even in the case of an advanced start of driving, for example midway between t₀ and t₁, a minimum charging energy is provided that ensures a minimum travel duration, respectively a minimum travel range. However, as soon as the minimum state of charge, which corresponds to the minimum travel range, respectively the minimum charging energy, is reached after first stage 40′ of the charging process, the state of charge remains constantly at level 40. A second stage of charging process 42 is carried out in accordance with the present invention in such a way that it is delayed to the extent possible in order to provide a minimum length of time between the end of the charging process (i.e., the end of the second stage of the charging process) and start of driving t₁. The start of the second stage ensues from the increase in second stage 42, which is induced by the charging current, as well as from the difference between the charging energy, respectively the state of charge that corresponds to the travel duration, respectively the travel range at start of driving t₁, and the minimum state of charge at the end of first stage 40′, which corresponds to a predefined minimum travel range. From the state-of-charge rate of rise in accordance with rise 42 and the difference between the minimum state of charge and the charging energy that corresponds to a travel duration, respectively a travel range at point in time t₁, the required time is derived by which the start of the (remaining) charging process is to be advanced relative to the scheduled start of driving. In accordance with the long dwell time at level 40, this variant renders possible a long battery time period that is linked to a low state of charge. Moreover, second stage 42 of the charging process does not end at a maximum possible state of charge, rather at a state of charge that corresponds to a travel duration, respectively a travel range. As a result, the state-of-charge cycle range is also reduced, thereby making it possible to reduce aging. In particular, at the end of the charging process according to the present invention, only the minimum necessary state of charge that renders possible a corresponding travel duration, respectively travel range, is provided, however, without charging energies that go beyond this being stored in the battery that would not be retrieved due to the travel range, respectively the scheduled travel duration, and thus would only contribute to intensified aging.

1-10. (canceled)

11. A method for prolonging service life of a traction battery of an electric-powered or hybrid vehicle, comprising:
recording at least one driving phase selection that encompasses at least one of a travel duration and a start of driving;
recording an instantaneous state of charge of the traction battery;
minimizing at least one aging parameter that encompasses one of: i) a time interval between a charging process and the start of driving, or ii) a charging energy used to charge the traction battery in accordance with at least one driving phase selection; and
executing the charging process in accordance with the minimized aging parameter.

12. The method as recited in claim 11, wherein the travel duration is recorded as the start of driving, the recording of the travel duration being provided by one of inputting an intended travel range or by retrieving at least one travel range of past drives; and the minimizating being provided by minimizing the charging energy on the basis of the travel range, the charging energy being estimated as a function of the travel range by a logic operation that is provided by one of an approximation formula, a ratio of state-of-charge reduction to the distance traveled in a past drive, an interpolation, or by a look-up table, and the executing of the charging process encompassing: charging the traction battery one of using the minimized charging energy or using the minimized charging energy that is increased by an availability safety margin.

13. The method as recited in claim 11, wherein the start of driving is recorded as the driving phase selection, the recording of the start of driving being provided one of by inputting an intended start of driving or by retrieving at least one start of driving of past drives; and the minimizating being provided in that a time interval until a beginning of the charging process is minimized on the basis of the start of driving and an estimated charging duration that is estimated as a function of a charge deficit and an available charging power, the charge deficit corresponding to a difference between a specified minimum state of charge and an instantaneous state of charge.

14. The method as recited in claim 13, wherein the minimum state of charge is estimated as a function of a travel range by a logic operation between the minimum state of charge and the travel range that is provided by one of an approximation formula, a ratio of state-of-charge reduction to a distance traveled in a past drive, an interpolation, or a look-up table.

15. The method as recited in claim 10, further comprising:
recording a temperature of the traction battery;
comparing the temperature to a minimum specified temperature; and
executing the charging process in accordance with the minimized aging parameter only when the comparing reveals that the recorded temperature corresponds to the minimum specified temperature or is above the minimum specified temperature.

16. The method as recited in claim 10, wherein a first stage of the charging process is not executed in accordance with the minimized aging parameter, and one other, second stage of the charging process is executed in accordance with the minimized aging parameter, the second stage being carried out following completion of the first stage.

17. The method as recited in claim 16, wherein the first stage of the charging process is provided by the charging of the traction battery to one of a specified minimum state of charge or a state of charge that corresponds to a minimum specified travel range, immediately following a connection of the electric-powered or hybrid vehicle, or of a charging device of the traction battery to a power supply system; and the second stage of the charging process encompassing the minimizating of at least one of delaying the charging process in accordance with the start of driving and the travel duration, executing the charging process in accordance with a charging energy that is minimized in accordance with the charging duration.

18. A charge control for a traction battery of an electric-powered or hybrid vehicle, comprising:
an input interface adapted for inputting a driving phase selection that encompasses at least one of a travel duration and a start of driving;
a state-of-charge detection device adapted to record an instantaneous state of charge of the traction battery;
a minimization device adapted to minimize an aging parameter that encompasses one of a time interval between a charging process and the start of driving, or the charging energy which is to be used to charge the traction battery in accordance with the driving phase selection and the state of charge, the minimization device adapted to optimize the time interval until at least one of a charging process in accordance with the travel duration and the start of driving, for optimizing the charging energy in accordance with the travel duration; and
an output adapted to output one of a charging signal or a charging current in accordance with the optimized aging parameter.

19. The charge control as recited in claim 12, further comprising:
a memory adapted to store values of one of past recorded travel durations or start-of-driving points in time, to transmit them in interpolated or averaged form to one of the input interface or to the minimization device in order to consider at least one of past travel durations and start-of-driving points in time in the minimization in accordance with the driving phase selection.

20. The charge control as recited in claim 19, further comprising:
a clock adapted to transmit a current clock time to the minimization device.
